(19) United States
(12) Patent Application Publication
(10) Pub. No.: US 2023/0328164 A1
(43) Pub. Date: Oct. 12, 2023

(54) MOBILE PHONE HOLDER

(71) Applicant: U2O GLOBAL CO., LTD., Xiamen (CN)

(72) Inventor: Aijun KANG, Xiamen (CN)

(21) Appl. No.: 17/863,860

(22) Filed: Jul. 13, 2022

(30) Foreign Application Priority Data
Apr. 6, 2022 (CN) 202220774234.1

(51) Int. Cl. H04M 1/04; F16M 13/02

(52) U.S. Cl. CPC H04M 1/04; F16M 13/02

(57) ABSTRACT

Disclosed is a mobile phone holder including a rotating disc and a fixed seat covered with each other. A support suction ring is provided on one side of the rotating disc and is configured for adsorbing a back surface of a mobile phone. The fixed seat is provided with an adhesive plate on one side away from the rotating disc and is adsorbed on a surface of an adsorbed object through the adhesive plate. A plurality of gear adjustment parts are provided in a circumferential direction of the inner side of the rotating disc. At least one gear adjusting piece is disposed on the fixed seat. The rotation angle of the rotating disc is adjusted by the corresponding cooperation between the gear adjusting piece and the gear adjustment parts at different positions. The rotating disc of the present invention has higher rotating stability, so that the user's experience is improved.

### RELATED APPLICATIONS

The present disclosure claims priority to Chinese Patent Application No. 202220774234.1, filed on Apr. 6, 2022, which is incorporated herein by reference.

### TECHNICAL FIELD

The present invention relates to the technical field of mobile phone holders, in particular to a mobile phone holder.

### BACKGROUND

The existing mobile phone holder in the prior art, such as bracelet-type mobile phone holder with a support arm disclosed in the patent application with a publication number CN108737607A, is attached to the back of the mobile phone case or the back cover of the mobile phone with the adhesive base plate made of strong adhesive material, which makes it inconvenient to disassemble the mobile phone holder, and the adhesive material is easy to remain on the disassembled mobile phone case, which affects the holding handfeel of a user. The rotation angle of the mobile phone is adjusted by the rotating base, however, the volume and rotating contact area of the rotating base are small, so it is impossible to rotate stably, and a gear selection cannot be carried out in the adjusting mode. After long-term use, the connection between the rotating base and the adhesive bottom plate will get looser, resulting in the rotating base being unable to fix the rotation angle, which affects the user experience.

### SUMMARY

The present invention aims to provide a mobile phone holder to solve at least one of the existing problems.

To achieve the above purpose, the technical solution of the present invention is as follows: a mobile phone holder including a rotating disc and a fixed seat covered with each other, wherein a support suction ring is provided on one side of the rotating disc and is configured for adsorbing a back surface of a mobile phone, the fixed seat is provided with an adhesive plate on one side away from the rotating disc and is adsorbed on a surface of an adsorbed object through the adhesive plate, a plurality of gear adjustment parts are provided in a circumferential direction of an inner side of the rotating disc, at least one gear adjusting piece is disposed on the fixed seat, and a rotation angle of the rotating disc is adjusted by corresponding cooperation between the gear adjusting piece and the gear adjustment parts at different positions.

With the above technical solution, the rotating disc and the fixed seat are covered with each other, a volume and a rotating contact area of the rotating disc are larger, and the rotating stability is higher, and the gear adjustment is implemented on the rotation angle of the rotating disc by the corresponding cooperation between the gear adjusting piece and the gear adjustment parts at different positions, thereby avoiding loosening after long-term use and ensuring the user's experience.

Preferably, two gear adjusting pieces are provided, a slotted hole for accommodating the gear adjusting piece is disposed on either of opposite two sides of the fixed seat, the gear adjusting piece comprises a spring and a ball body connected with each other, the gear adjustment part is a spherical groove, and the ball body correspondingly fits into the spherical groove. The arrangement makes the gear adjustment of the rotation angle of the rotating disc more stable and smooth.

Preferably, a plurality of gear adjustment parts are continuously and uniformly arranged in the circumferential direction of the inner side of the rotary disc. The arrangement enables the rotation angle of the rotating disc to be uniformly adjusted, thus the adjustment accuracy is finer, and the adjustment process is more coherent and smooth.

Preferably, the support suction ring includes an annular body and a magnet disposed in the annular body, and a silica gel sticker is further provided at a position corresponding to the magnet on the annular body. The arrangement allows the back of the mobile phone to be subjected to a magnetic adsorption of the magnet so that the silica gel sticker is closely attached to the back of the mobile phone to ensure the stability of adsorption and attachment.

Preferably, the mobile phone holder also includes an angle adjusting piece, one end of the angle adjusting piece is connected to the rotary disc in an angle-adjustable manner, and the other end of the angle adjusting piece is connected to an inner side of the support suction ring in an angle-adjustable manner. The arrangement allows a wider range of angle adjustment and enables any angle adjustment and switching.

Preferably, an angle adjustment range between the angle adjusting piece and the rotating disc is 0 to 100°, and an angle adjustment range between the angle adjusting piece and the support suction ring is 0 to 110°. These angle adjustment ranges can meet the needs of daily angle adjustment, and the angle adjusting piece and the support suction ring can be folded without interference with each other, which features thinner and lighter and being convenient for storage and carrying.

Preferably, the adhesive plate is a 3M adhesive plate or a removable adhesive plate, which can be pasted on any flat and smooth table top.

Preferably, the mobile phone holder also includes a connecting piece installed in a middle part of the rotating disc away from the fixed seat and a mounting piece located in a middle part of the fixed seat away from the rotating disc, the middle parts of the rotating disc and the fixed seat being provided with corresponding through holes, and the connecting piece penetrating the through holes of the rotating disc and the fixed seat to be fixedly connected with the mounting piece.

The present invention has the following beneficial effects:
(1) in the present invention, the rotating disc and the fixed seat are covered with each other, which increases the volume of the rotating disc and makes the rotating contact area larger so that the stability of rotation is higher, a plurality of gear adjustment parts are disposed in the circumferential direction of the inner side of the rotating disc, at least one gear adjusting piece is disposed on the fixed seat, and the gear adjustment is implemented on the rotation angle of the rotating disc by the corresponding cooperation between the gear adjusting piece and the gear adjustment parts at different positions, which ensures that the rotating disc can be fixed after being adjusted to a proper position, avoids loosening after being used for a long time, and improves the use experience of users.
(2) Either of the opposite two sides of the fixed seat is provided with a slotted hole for accommodating the gear adjusting piece, the gear adjusting piece includes a spring and a ball body connected with each other, the gear adjustment part is a spherical groove, a plurality of spherical grooves are continuously and uniformly disposed in the circumferential direction of the inner side of the rotating disc, and the ball body correspondingly fits into the spherical groove. The arrangement enables the rotation angle of the rotating disc to be uniformly adjusted, thus the adjustment accuracy is finer, and the adjustment process is more coherent and smooth.
(3) The adhesive plate is a 3M adhesive plate or a removable adhesive plate, which can be pasted on any flat and smooth table top such as desktop or wall, the present invention features a wider application range of the use scene, and being easy for disassembling and separating, and being not easy to leave adhesive substances, and improving the user's experience.

### BRIEF DESCRIPTION OF DRAWINGS

FIG. 1 is a schematic diagram of a mobile phone holder being used in conjunction with a mobile phone in an unfolded state according to an embodiment of the present invention;

FIG. 2 is a schematic diagram of the mobile phone holder in the unfolded state according to an embodiment of the present invention;

FIG. 3 is a schematic diagram of the mobile phone holder in a folded state according to an embodiment of the present invention; and

FIG. 4 is a disassembly schematic diagram of the mobile phone holder according to an embodiment of the present invention.

In the drawings: 1 support suction ring, 11 silica gel sticker, 12 magnet, 13 annular body, 2 rotating disc, 21 spherical groove, 3 fixed seat, 31 slotted hole, 4 adhesive plate, 5 angle adjusting piece, 6 connecting piece, 7 mounting piece, 8 gear adjustment part, 81 spring, 82 ball body and 9 mobile phone.

### DETAILED DESCRIPTION OF EMBODIMENTS

To further illustrate each embodiment, the present invention is provided with the accompanying drawings. The drawings, which are a part of the disclosure of the present invention, are mainly used to illustrate embodiments, and can be taken in conjunction with the relative contents in the description, to explain the operation principle of the embodiments. Other possible embodiments, as well as the advantages of the present invention, will be understood by those skilled in the art with reference to these contents. The components in the drawings are not drawn to scale, and similar component signs are usually used to represent similar components.

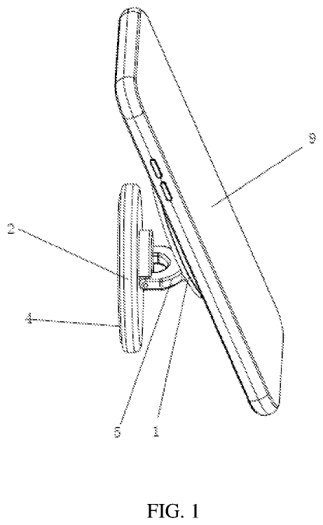

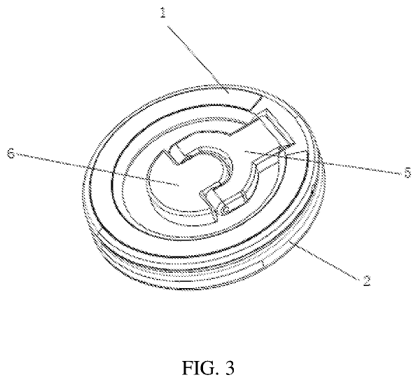

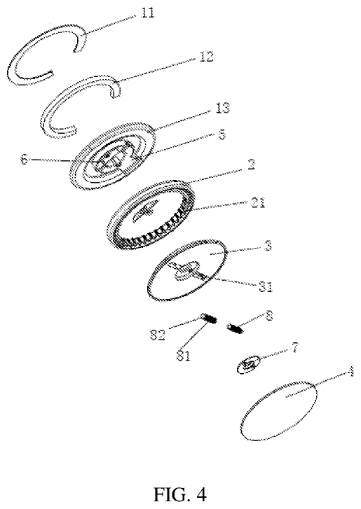

Referring to FIGS. 1-4, as an embodiment of the present invention, provided is a mobile phone holder, which includes a rotating disc 2 and a fixed seat 3 which are covered with each other. The mobile phone holder also includes a connecting piece 6 installed in a middle part of the rotating disc 2 away from the fixed seat 3 and a mounting piece 7 located in a middle part of the fixed seat 3 away from the rotating disc 2, the middle parts of the rotating disc and the fixed seat 3 are provided with corresponding through holes, and the connecting piece 6 penetrates the through holes of the rotating disc 2 and the fixed seat 3 to be fixedly connected with the mounting piece 7. An angle adjusting piece 5 is rotatably connected to the connecting piece 6, and the other end of the angle adjusting piece 5 is rotatably connected to a support suction ring 1. The support suction ring 1 is used for adsorbing a back surface of a mobile phone 9. The fixed seat 3 is provided with an adhesive plate 4 on one side away from the rotating disc 2 and is adsorbed on a surface of an adsorbed object through the adhesive plate 4. A plurality of gear adjustment parts are provided in a circumferential direction of an inner side of the rotating disc 2, two gear adjusting pieces 8 are disposed on the fixed seat 3, and a rotation angle of the rotating disc 2 is adjusted by corresponding cooperation between the gear adjusting pieces 8 and the gear adjustment parts at different positions.

With the above technical solution, the rotating disc 2 and the fixed seat 3 are covered with each other, a volume and a rotating contact area of the rotating disc 2 are larger, and the rotating stability is higher, and the gear adjustment is implemented on the rotation angle of the rotating disc 2 by the corresponding cooperation between the gear adjusting piece 8 and the gear adjustment parts at different positions, thereby avoiding loosening after long-term use and ensuring the user's experience.

In this embodiment, two gear adjusting pieces 8 are provided, a slotted hole 31 for accommodating the gear adjusting piece 8 is disposed on either of opposite two sides of the fixed seat 3, the gear adjusting piece 8 includes a spring 81 and a ball body 82 connected with each other, the gear adjustment part is a spherical groove 21, and the ball body 82 correspondingly fits into the spherical groove 21. The arrangement makes the gear adjustment of the rotation angle of the rotating disc 2 more stable and smooth.

Of course, in other embodiments, the gear adjusting piece may be a spring and a cone, and the gear adjustment part is a tapered groove corresponding to the cone.

In this embodiment, a plurality of gear adjustment parts are continuously and uniformly arranged in the circumferential direction of the inner side of the rotary disc 2. The arrangement enables the rotation angle of the rotating disc 2 to be uniformly adjusted, thus the adjustment accuracy is finer, and the adjustment process is more coherent and smooth.

In this embodiment, the support suction ring 1 includes an annular body 13 and a magnet 12 disposed in the annular body 13, and a silica gel sticker 11 is further provided at a position corresponding to the magnet 12 on the annular body 13. The arrangement allows the back of the mobile phone 9 to be subjected to a magnetic adsorption of the magnet 12 so that the silica gel sticker 11 is closely attached to the back of the mobile phone 9 to ensure the stability of adsorption and attachment, and the silica gel sticker is easy for disassembling and separating, so that residual adhesive substances are prevented from being adhered to the back surface of a mobile phone casing or the back surface of the mobile phones like the adhesive base plate made of strong adhesive material in the prior art, and user experience is improved.

In this embodiment, the adhesive plate 4 is a 3M adhesive plate or a removable adhesive plate, which can be pasted on any flat and smooth table top such as desktop or wall, the present invention features a wider application range of the use scene, and being easy for disassembling and separating, and being not easy to leave adhesive substances, and improving the user's experience.

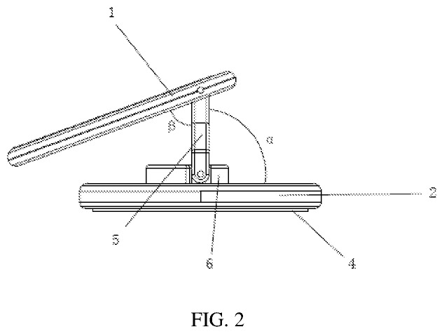

In this embodiment, one end of the angle adjusting piece 5 is connected to the rotary disc 2 in an angle-adjustable manner, and the other end of the angle adjusting piece 5 is connected to an inner side of the support suction ring 1 in an angle-adjustable manner. The arrangement allows a wider range of angle adjustment and enables switching of any angle adjustment. Specifically, as shown in FIG. 2, an angle adjustment range of an angle α between the angle adjusting piece 5 and the rotating disc 2 is 0 to 100°, and an angle adjustment range of an angle β between the angle adjusting piece 5 and the support suction ring 1 is 0 to 110°. The angle adjustment ranges of the angle α and angle β can meet the needs of daily angle adjustment, and the angle adjusting piece 5 and the support suction ring 1 can be folded without interference with each other so that the present invention features thinner and lighter and being convenient for storage and carrying.

The main body of the mobile phone holder of the present invention is manufactured by metal baking paint, which can manufacture mobile phone holders with various colors to meet various requirements of users.

The use flow of the present invention is as follows:

the mobile phone holder is used by first sticking and fixing the adhesive plate 4 on any flat and smooth table top, then absorbing and attaching the back of the mobile phone 9 to the support suction ring 1, adjusting the angle between the angle adjusting piece 5 and the rotating disc 2 and the angle between the support suction ring 1 and the angle adjusting piece 5, then adjusting the rotation angle of the rotating disc 2 to meet the suitable viewing requirements and meet the viewing requirements of users, and finally adjusting positions of the support suction ring 1 and the mobile phone 9 adsorbed on the support suction ring 1.

When it is necessary to store and carry the mobile phone holder, only the mobile phone 9 needs to be removed from the support suction ring 1, and then the support suction ring 1 and the angle adjusting piece 5 are folded and stored on one side of the rotating disc 2 so that the mobile phone holder forms a thin disc structure with smaller volume and is convenient for storage and carrying.

Although the present invention has been particularly shown and described in connection with preferred embodiments, it will be apparent to those skilled in the art that various changes in form and detail may be made therein without departing from the spirit and scope of the present invention as defined by the appended claims, fall within the scope of protection of the present invention.

1. A mobile phone holder comprising a rotating disc and a fixed seat covered with each other, wherein a support suction ring is provided on one side of the rotating disc and is configured for adsorbing a back surface of a mobile phone, the fixed seat is provided with an adhesive plate on one side away from the rotating disc and is adsorbed on a surface of an adsorbed object through the adhesive plate, a plurality of gear adjustment parts are provided in a circumferential direction of an inner side of the rotating disc, at least one gear adjusting piece is disposed on the fixed seat, and a rotation angle of the rotating disc is adjusted by corresponding cooperation between the gear adjusting piece and the gear adjustment parts at different positions.

2. The mobile phone holder according to claim 1, wherein two gear adjusting pieces are provided, a slotted hole for accommodating the gear adjusting piece is disposed on either of opposite two sides of the fixed seat, the gear adjusting piece comprises a spring and a ball body connected with each other, the gear adjustment part is a spherical groove, and the ball body correspondingly fits into the spherical groove.

3. The mobile phone holder according to claim 1, wherein a plurality of gear adjustment parts are continuously and uniformly arranged in the circumferential direction of the inner side of the rotary disc.

4. The mobile phone holder according to claim 1, wherein the support suction ring comprises an annular body and a magnet disposed in the annular body, and a silica gel sticker is further provided at a position corresponding to the magnet on the annular body.

5. The mobile phone holder according to claim 1, further comprising an angle adjusting piece, one end of the angle adjusting piece is connected to the rotary disc in an angle-adjustable manner, and the other end of the angle adjusting piece is connected to an inner side of the support suction ring in an angle-adjustable manner.

6. The mobile phone holder according to claim 5, wherein an angle adjustment range between the angle adjusting piece and the rotating disc is 0 to 100°, and an angle adjustment range between the angle adjusting piece and the support suction ring is 0 to 110°.

7. The mobile phone holder according to claim 1, wherein the adhesive plate is a 3M adhesive plate or a removable adhesive plate.

8. The mobile phone holder according to claim 1, further comprising a connecting piece installed in a middle part of the rotating disc away from the fixed seat and a mounting piece located in a middle part of the fixed seat away from the rotating disc, the middle parts of the rotating disc and the fixed seat being provided with corresponding through holes, and the connecting piece penetrating the through holes of the rotating disc and the fixed seat to be fixedly connected with the mounting piece.
